(19) United States
(12) Patent Application Publication
(10) Pub. No.: US 2015/0039543 A1
(43) Pub. Date: Feb. 5, 2015

(54) Feature Based Three Stage Neural Network Intrusion Detection

(71) Applicants: Balakrishnan Athmanathan, Bangalore (IN); Supriya Kamthania, Bangalore (IN)

(72) Inventors: Balakrishnan Athmanathan, Bangalore (IN); Supriya Kamthania, Bangalore (IN)

(21) Appl. No.: 14/446,896

(22) Filed: Jul. 30, 2014

(30) Foreign Application Priority Data
Jul. 31, 2013 (EP) 13178653.5

(51) Int. Cl. H04L 29/06; G06F 21/55; G06N 3/08

(52) U.S. Cl. CPC H04L 63/14; G06N 3/084; G06F 21/55
USPC 706/20; 726/23

(57) ABSTRACT

A system for detecting a network intrusion includes a first neural network for determining a first plurality of weight values corresponding to a plurality of vectors of an input data, a second neural network for updating the first plurality of weight values received from the first neural network to a second plurality of weight values based on the plurality of vectors of the input data, a third neural network for updating the second plurality of weight values received from the second neural network to a third plurality of weight values based on the plurality of vectors of the input data, and a classification module for classifying the plurality of vectors under at least one of a plurality of intrusions based on the third plurality of weight values received from the third neural network.

This application claims the benefit of EP 13178653.5, filed on Jul. 31, 2013, which is hereby incorporated by reference in its entirety.

### FIELD

The present embodiments relate to intrusion detection and more particularly, to feature based three stage neural network intrusion detection.

### BACKGROUND

In the present world, most organizations have local area networks (LANs) for intra-organization communication. Organization's servers are connected with these LANs and all organization related data is transferred over these networks. To communicate with vendors, customers and other organizations, these LANs are connected to a wide area network (WAN), such as the Internet. Such connections with WANs make the LANs vulnerable to intrusions. The intrusions pose a serious security risk to the internal data of the organization. Damages caused by the intrusions are unauthorized modifications of the system files, user files or any other information related to the organization. The intrusions may cost companies a huge amount of money and time. Hence it becomes very important to detect and prevent the intrusions before they cause any damage to the network.

Various intrusion detection methods and systems are known. Intrusion detection is a task of detecting, preventing and possibly reacting to the intrusions on a system running over a network. Most of the intrusion detection techniques are based on misuse detection. Misuse detection is a process of attempting to identify instances of intrusions by comparing current activity against the expected actions of an intruder. Misuse detection is primarily done using some form of pattern matching. One of the largest challenges for misuse intrusion detection is to be able to generalize from a previously observed behavior, e.g., normal or malicious behavior, to recognize similar types of future behavior. Anomaly detection is an answer to this challenge.

Anomaly based intrusion detection systems observe activities that deviate significantly from established normal usage profiles over a network. Such anomalies are possibly intrusions. In anomaly detection, normal behavior of the network is modelled and an alarm is raised if any behavior of the network does not match the modelled normal behavior. For example, a profile of a user over the network may present an average frequency of some system commands during his or her logging session. If the frequency of those system commands significantly varies during a logging session of the user being monitored, an anomaly alarm is raised.

Anomaly detection is an effective technique for detecting unknown intrusions because anomaly detection does not require any knowledge about intrusions. But the major drawback of this detection technique is a high false alarm rate. The high false alarm rate is because an alert is raised if the frequency of the detected event is different from the average frequency for the user profile being monitored, irrespective of the type of event, e.g., normal or abnormal event, occurring in the network. The specific reasons for the high false alarm rate include, for example, bad packets generated by software bugs, corrupt data packets, and other reasons. Due to the high false alarm rate, real intrusions are often missed or ignored.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the disclosed embodiments may provide an improved method and system intrusion detection over various networks.

An efficient network intrusion detection method and system with a lower false alarm rate may be provided.

In one aspect, a method for detecting network intrusion uses a plurality of neural networks. A dataset is received as an input, and a first plurality of weight values corresponding to a plurality of vectors of the input data at a first neural network of the plurality of neural networks are determined. The first plurality of weight values are received and updated to a second plurality of weight values by a second neural network of the plurality of neural networks. The second plurality of weight values are updated to a third plurality of weight values at a third neural network of the plurality of neural networks. The plurality of vectors are classified under at least one of a plurality of intrusions based on the third plurality of weight values.

The plurality of neural networks may be trained to detect network intrusion using training data.

A classification map of the first neural network may be formed using the training data.

The plurality of vectors may be mapped on the classification map of the first neural network.

The first plurality of weight values may be associated with the classification map of the first neural network.

The plurality of intrusions may be defined based on the training data.

The second plurality of weight values may be determined from the first plurality of weight values and the plurality of vectors at the second neural network before updating the first plurality of weight values to the second plurality of weight values.

The third plurality of weight values may be determined from the second plurality of weight values and the plurality of vectors at the third neural network before updating the second plurality of weight values to the third plurality of weight values.

In one aspect, a method identifies an intrusion detection feature from a plurality of features for a data set. One or more values of a feature of the plurality of features for the data set are determined. The data set is divided in one or more data subsets based on the one or more values of the feature. Entropy of the feature is determined from the one or more values and a predefined class of the feature for the one or more data subsets. The entropy of the feature is used to determine an information gain for the feature. The information gain of the feature is compared with a predefined value of the information gain.

The predefined class may be determined for the feature of the plurality of the features.

In one aspect, a network intrusion detection system uses a plurality of neural networks. The system includes a first neural network to determine a first plurality of weight values corresponding to a plurality of vectors of an input data. The system also includes a second neural network to update the first plurality of weight values received from the first neural network to a second plurality of weight values based on the plurality of vectors of the input data. The system also includes a third neural network to update the second plurality of weight values received from the second neural network to a third plurality of weight values based on the plurality of vectors of the input data. The system also includes a classification module to classify the plurality of vectors under at least one of a plurality of intrusions based on the third plurality of weight values received from the third neural network.

The system may also include a feature detector to identify at least one intrusion detection feature from a plurality of features of the input data.

### BRIEF DESCRIPTION OF THE DRAWINGS

FIG. 1 illustrates a block diagram of a feature based three stage neural network intrusion detection system in accordance with one embodiment.

FIG. 2 illustrates a flow chart for a three stage neural network intrusion detection method in accordance with one embodiment.

### DETAILED DESCRIPTION

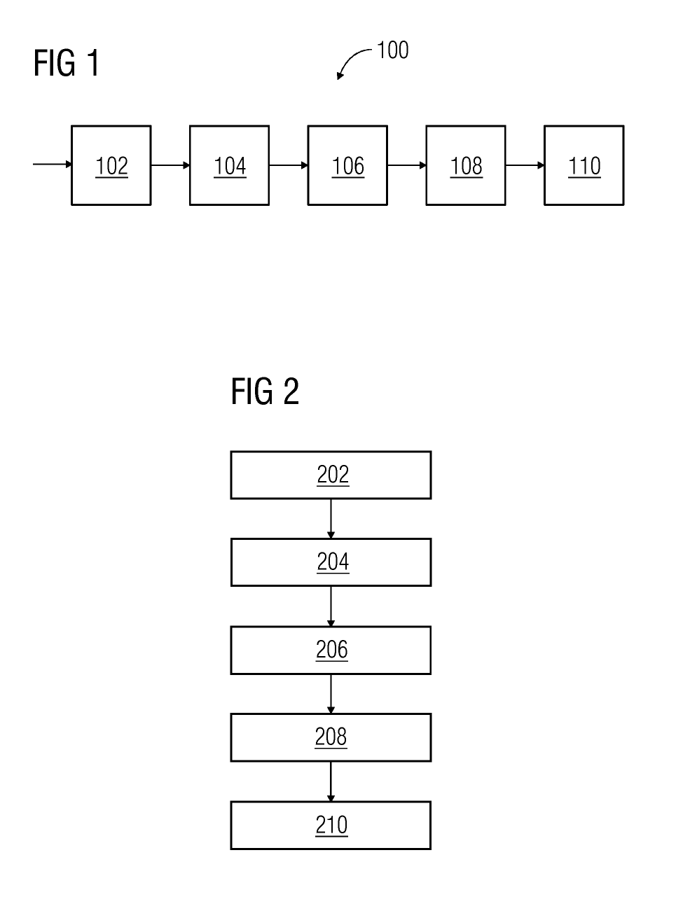

FIG. 1 illustrates a block diagram of a feature based three stage neural network intrusion detection system 100 in accordance with one embodiment. The detection system 100 is implemented by a processor, such as a computer or server. The computer, server, or other processor may be connected to the network for which intrusion detection is provided. A non-transitory memory stores the matrices or other constructs for the detection system 100 as well as instructions for configuring the processor to apply the detection system 100. The memory may store feature sets and weights.

As shown in FIG. 1, the network intrusion detection system 100 includes a feature detector 102, a self organizing feature maps (SOFM) neural network 104, a multi-layered feed forward (MLFF) neural network 106, an Elman back propagation (ELBP) neural network 108 and a classification module 110. The feature detector 102 receives input data. The input data includes all of the data features and a class associated with each data feature. The class of the data feature may be continuous, discrete or symbolic. The feature detector 102 detects the relevant features for intrusion detection from the available data features.

The feature detector 102 analyzes (e.g., checks) all data features sequentially (e.g., one by one) to identify the features relevant to intrusion detection. During the process for analyzing the relevancy for intrusion detection of a feature from the data features, the feature detector 102 determines all of the values of the feature under analysis for all values of the input data. For example, assuming feature F is a feature for input data S and feature F is to be analyzed for relevancy to intrusion detection. The feature detector 102 identifies the values of F for each value of the input data S. The values of F identified by the feature detector 102 are {f₁,f₂,f₃, . . . ,fᵥ}. Based on the identified values of F, i.e. {f₁,f₂,f₃, . . . ,fᵥ}, the input data set S is divided in subsets, such as {S₁,S₂,S₃, . . . , Sᵥ}, where Sⱼ is the subset of input data S for which the value of feature F is fⱼ. The set Sⱼ has sᵢⱼ samples of class i. The feature detector 102 calculates an entropy E of the feature F using the following formula:

$$E ( F ) = {\sum }_{j = 1}^{v} \frac{{s}_{1 j} + {s}_{2 j} + … + {s}_{mj}}{s} \times I ( {s}_{1 j} + {s}_{2 j} + … + {s}_{mj} )$$

Based on the entropy E of a feature, the information gain measures the relevancy to intrusion detection for a given feature. For the above mentioned example of feature F, an information gain G is calculated from entropy E of the feature F as follows:

G(F)=1(s₁, s₂, . . . sₘ)−E(F)

The value of the information gain G for each feature of the input data is calculated and compared with a predefined value of the information gain. In one embodiment, the predefined value of the information gain is 1. For the above mentioned example, if G(F) is approximately equal to 1, e.g., equal to the predefined value of information gain, then the feature F is relevant for intrusion detection. In other words, if the value of entropy E(F) is approximately equal to 0, e.g., a predefined value of feature entropy E, than the feature F is considered relevant for intrusion detection.

For simulation purposes, a KDD 99 dataset is used as input data for the feature detector 102. The KDD 99 dataset is an intrusion detection dataset based on a DARPA initiative, which provides intrusion detection system (IDS) designers a benchmark to evaluate different methodologies of intrusion detection. The KDD 99 dataset is used as input data to evaluate the intrusion detection approach described herein. The KDD 99 dataset has 41 features. The feature detector 102 identified 30 features relevant to intrusion detection out of the available 41 features of the KDD 99 dataset. The feature detector 102 identified 30 relevant features using the methodology described above.

The three neural networks shown in FIG. 1, namely the SOFM neural network 104, the MLFF neural network 106 and the ELBP neural network 108, are connected in series. The three neural networks 104, 106 and 108 are trained neural networks. The three neural networks 104, 106 and 108 are trained using the KDD 99 dataset. The first neural network 104, e.g., the SOFM neural network 104, receives the input data from the feature detector 102. The SOFM neural network 104 does not receive all of the features of the input data, but rather only receives the features of the input data that have been identified as relevant to intrusion detection by the feature detector 102. The SOFM neural network 104 is an unsupervised learning neural network, e.g., the network is trained on unlabelled data and attempts to form clusters based on some rules and then labels the input data. The SOFM neural network 104 is primarily used for classifying unknown records to various classes. As described above, the SOFM neural network 104 is trained using the KDD 99 dataset. During the training process, the SOFM neural network 104 receives the KDD 99 data set from the feature detector 102. The KDD 99 dataset received by the SOFM neural network 104 has 30 features that are most relevant for intrusion detection, as opposed to the original 41 features. The SOFM neural network 104 builds a classification map using a competitive process as known in the art using the KDD 99 dataset received from the feature detector 102 during the training process. It is useful to provide a large number of input vectors, e.g., the input dataset, during the training process so that the SOFM neural network 104 may build an exhaustive classification map. Once the training process is completed, the trained SOFM neural network 104 is used to map the input vectors of the dataset received from the feature detector 102 having only the features relevant for intrusion detection to the classification map built during the training process. The input vectors for the SOFM neural network 104 are automatically categorized by identifying a neuron on the classification map having a weight value closest to an input vector. The neuron may be determined by calculating Euclidean distance between the input vector and the weight value as known in the art. In one embodiment, the first neural network, e.g., the SOFM neural network 104, may be replaced with any other neural network.

As shown in FIG. 1, the weight values corresponding to each input vector of the input data are fed to the MLFF neural network 106 along with the input vectors by the SOFM neural network 104. The MLFF neural network 106 is based on supervised learning and uses a back propagation algorithm to capture the non-linear relationships between the records in order to classify the input data to an appropriate class. The MLFF neural network 106 is trained using a back algorithm. The MLFF neural network 106 may be modified to perform certain tasks by selecting the number of input neurons, output neurons, hidden neurons and neuron interconnections. The number of hidden neurons is directly related to the capabilities of the MLFF neural network 106. Hence the number of hidden neurons is highly useful for optimizing the performance of the MLFF neural network 106. An optimal number of hidden neurons is determined by using a trial and error method as known in the art. As mentioned above, the back propagation algorithm is used to train the MLFF neural network 106. Hence the MLFF neural network 106 propagates the weight values received from the SOFM neural network 104 from the output neurons of the MLFF neural network 106 to the hidden neurons of the MLFF neural network 106, which, in turn, updates the weight values received from the SOFM neural network 104. In one embodiment, the second neural network, e.g., the MLFF neural network 106, may be replaced with any other neural network.

As shown in FIG. 1, the MLFF neural network 106 feeds or provides the updated weight values to the ELBP neural network 108. The ELBP neural network 108 is a fully recurrent network based on supervised learning. In the ELBP neural network 108, every neuron receives inputs from every other neuron in the network. Usually only a subset of the neurons receive external inputs in addition to the inputs from all the other neurons, and another disjoint subset of neurons report their output externally as well as sending the output to all of the neurons. The ELBP neural network 108 is also a type of recurrent neural network similar to the MLFF neural network 106. The ELBP neural network 108 further updates the received updated weight values from the MLFF neural network 106. In one embodiment, the third neural network, e.g., the ELBP neural network 108, may be replaced with any other neural network.

As shown in FIG. 1, the updated weight values are fed or provided to the classification module 110 by the ELBP neural network 108 in the form of a weight matrix. The classification module 110 classifies the vectors of the input data under predefined types of intrusions based on the received weight matrix. The predefined types of intrusions include the definition of all possible types of intrusions that the network intrusion detection system 100 is capable of detecting. In an exemplary embodiment, the classification module 110 is capable of classifying a test sample of KDD 99 dataset under five intrusion categories, including: (1) Normal, when no intrusion is detected; (2) a Denial of service (DoS) intrusion, when an intruder makes a computing or memory resource too busy or too full to handle legitimate requests; (3) a Probe intrusion, when an intruder scans a network to gather information; (4) a User to root (U2R) intrusion, when an intruder gains access of a normal user account on the system; and (5) a Remote to user (R2L) intrusion, when an intruder sends packets to a machine over a network. However the types of intrusions are not limited to the five types mentioned above. The classification module 110 may have any number of intrusions types.

FIG. 2 illustrates a flow chart for a three stage neural network intrusion detection method in accordance with one embodiment.

In act 202, all data features of the input data are analyzed (e.g., checked) sequentially (e.g., one by one) to identify the features relevant to intrusion detection by the feature detector 102, as described in connection with FIG. 1. Multiple exemplary techniques for analyzing the relevancy of a data feature for intrusion detection are also described in connection with FIG. 1.

In act 204, the first neural network, e.g., the SOFM neural network 104 shown in FIG. 1, receives the input vectors of the input data and only the features of the input data identified as relevant to intrusion detection in act 202. The SOFM neural network 104 assigns the weight value to each input vector of the input data as described in connection with FIG. 1. Multiple exemplary techniques for assigning weight values of the input vectors are also described in connection with FIG. 1.

In act 206, the second neural network, e.g., the MLFF neural network 106, shown in FIG. 1, receives the weight values associated with the input vectors of the input data determined in act 204. The MLFF neural network 106 updates the weight value to each input vector of the input data as described in connection with FIG. 1. Multiple exemplary techniques for updating the weight values of the input vectors are also described in connection with FIG. 1.

In act 208, the third neural network, e.g., the ELBP neural network 108 of FIG. 1, receives the updated weight values from the MLFF neural network 106 determined in act 206. The ELBP neural network 108 further updates the received weight value as described in connection with FIG. 1. Multiple exemplary techniques for further updating the weight values of the input vectors by the ELBP neural network 108 are also described in connection with FIG. 1.

In act 210, the updated weight values determined in act 208 are received by the classification module 110 as shown in FIG. 1. The updated weight values are fed to the classification module 110 in the form of the weight matrix by the ELBP neural network 108 as described in connection with FIG. 1. The classification module 110 classifies the vectors of the input data under predefined types of intrusions based on the received weight matrix as described in connection with FIG. 1. Multiple exemplary techniques for classifying the vectors of the input data under predefined types of intrusions are also described in connection with FIG. 1.

Methods and systems for feature based three stage neural networks intrusion detection are provided. The methods and systems for detecting network intrusion use three stage neural network for intrusion detection. Due to the self-learning nature of the neural networks, the efficiency of the systems for detecting network intrusion may increase with time, thereby leading to a lower false alarm rate.

The methods and systems for detecting network intrusion are also capable of identifying the features of the input dataset that are relevant for intrusion detection. Due to this property of the intrusion detection systems, the systems process the relevant features of the input dataset rather than all of the features, which, in turn, reduces the load on the system. The intrusion detection system may thus be faster and more efficient relative to other intrusion detection systems.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for detecting network intrusion using a plurality of neural networks, the method comprising:
determining a first plurality of weight values corresponding to a plurality of vectors of input data at a first neural network of the plurality of neural networks;
updating the first plurality of weight values to a second plurality of weight values at a second neural network of the plurality of neural networks;
updating the second plurality of weight values to a third plurality of weight values at a third neural network of the plurality of neural networks; and
classifying the plurality of vectors under at least one of a plurality of intrusions based on the third plurality of weight values.

2. The method of claim 1, further comprising training the plurality of neural networks to detect network intrusion using training data.

3. The method of claim 2, further comprising forming a classification map of the first neural network using the training data.

4. The method of claim 3, further comprising mapping the plurality of vectors on the classification map of the first neural network.

5. The method of claim 4, wherein the first plurality of weight values is associated with the classification map of the first neural network.

6. The method of claim 2, further comprising defining the plurality of intrusions based on the training data.

7. The method of claim 1, wherein determining the first plurality of weight values further comprises providing the first plurality of weight values and the plurality of vectors to the second neural network.

8. The method of claim 1, further comprising determining the second plurality of weight values from the first plurality of weight values and the plurality of vectors at the second neural network before updating the first plurality of weight values to the second plurality of weight values.

9. The method of claim 1, wherein updating the first plurality of weight values comprises providing the second plurality of weight values and the plurality of vectors to the third neural network.

10. The method of claim 1, further comprising determining the third plurality of weight values from the second plurality of weight values and the plurality of vectors at the third neural network before updating the second plurality of weight values to the third plurality of weight values.

11. A method for identifying an intrusion detection feature from a plurality of features for a dataset, the method comprising:
determining one or more values of a respective feature of the plurality of features for the dataset;
dividing the dataset into one or more data subsets based on the one or more values of the respective feature;
determining an entropy of the respective feature from the one or more values and a predefined class of the respective feature for the one or more data subsets;
determining an information gain for the respective feature from the entropy of the respective feature; and
comparing the information gain of the respective feature with a predefined value of the information gain.

12. The method of claim 11, further comprising identifying the predefined class for the respective feature of the plurality of the features.

13. The method of claim 11, wherein comparing the information gain comprises comparing the entropy of the respective feature with a predefined value of the entropy.

14. A network intrusion detection system using a plurality of neural networks, the system comprising:
a processor configured to apply:
a first neural network to determine a first plurality of weight values corresponding to a plurality of vectors of input data;
a second neural network to update the first plurality of weight values received from the first neural network to a second plurality of weight values based on the plurality of vectors of the input data;
a third neural network to update the second plurality of weight values received from the second neural network to a third plurality of weight values based on the plurality of vectors of the input data; and
a classification module to classify the plurality of vectors under at least one of a plurality of intrusions based on the third plurality of weight values received from the third neural network.

15. The network intrusion detection system of claim 14, further comprising a feature detector to identify at least one intrusion detection feature from a plurality of features of the input data.

16. The method of claim 1, wherein:
determining the first plurality of weight values further comprises providing the first plurality of weight values and the plurality of vectors to the second neural network; and
updating the first plurality of weight values comprises providing the second plurality of weight values and the plurality of vectors to the third neural network.

17. The method of claim 1, further comprising:
determining the second plurality of weight values from the first plurality of weight values and the plurality of vectors at the second neural network before updating the first plurality of weight values to the second plurality of weight values; and
determining the third plurality of weight values from the second plurality of weight values and the plurality of vectors at the third neural network before updating the second plurality of weight values to the third plurality of weight values.

18. The method of claim 1, further comprising:
determining the second plurality of weight values from the first plurality of weight values and the plurality of vectors at the second neural network before updating the first plurality of weight values to the second plurality of weight values; and
determining the third plurality of weight values from the second plurality of weight values and the plurality of vectors at the third neural network before updating the second plurality of weight values to the third plurality of weight values,
wherein:
determining the first plurality of weight values further comprises providing the first plurality of weight values and the plurality of vectors to the second neural network; and
updating the first plurality of weight values comprises providing the second plurality of weight values and the plurality of vectors to the third neural network.
